(19) United States
(12) Patent Application Publication
(10) Pub. No.: US 2013/0140796 A1
(43) Pub. Date: Jun. 6, 2013

(54) VEHICLE FRAME JOINT OF SCOOTER

(71) Applicant: CHEN-CHI HSIAO, CHIA YI CITY (TW)

(72) Inventor: CHEN-CHI HSIAO, CHIA YI CITY (TW)

(73) Assignee: SUNPEX TECHNOLOGY CO., LTD., CHIA YI CITY (TW)

(21) Appl. No.: 13/309,729

(22) Filed: Dec. 2, 2011

(51) Int. Cl. B62B 3/02

(52) U.S. Cl. 280/639

(57) ABSTRACT

A vehicle frame joint of a folding scooter is revealed. Connection rods, main hooks with openings facing upward, and side hooks with openings facing downward are disposed between a front frame and a rear frame. While in use, the connection rods of one frame are assembled with or separated from the main and side hooks of the other frame so as to assemble or disassemble the front frame and the rear frame. By the simple design of the joint, even the disabled or users with poor physical health can disassemble/assemble the vehicle frame of the folding scooter easily by themselves.

### BACKGROUND OF THE INVENTION

1. Field of the Invention

The present invention relates to a vehicle frame joint of a scooter, especially to a vehicle frame joint of a folding scooter that can be assembled and disassembled easily and quickly by users with physical disabilities or poor physical health themselves.

2. Description of Related Art

Some people have problems with mobility while walking or standing due to car accidents, diseases (such as stroke) injuries to legs, or poor physical health. When these people intend to move, they need mobility aids such as canes, wheelchairs, scooters, etc. Although scooters available on the market now help people with restricted mobility to move around with ease, they are designed in an integrated piece, unable to be folded. While not in use, the scooter takes quite a lot space. Moreover, this causes inconvenience in storage and transportation.

Thus a folding scooter in which a vehicle frame and a seat are foldable is invented. Refer to Taiwanese Pat. No. M374858 “vehicle frame and seat of scooter”, a main rod and a sleeve sleeved with each other are disposed between a front frame and a rear frame. A seat is connected to the rear frame by a support rod. By the sleeve and the main rod between the front and rear frames, the front frame and the rear frame are folded smoothly. The support rod lifts, lowers and folds the seat by a first link rod and a second link rod staggered with and pivoted to each other. Thereby both the vehicle frame and seat are arranged with folding members so that the volume of the scooter is reduced effectively for easy storage and convenient transportation.

However, for connecting the front frame and the rear frame revealed in the Taiwanese Pat. No. M374858, the main rod of the front frame needs to be aligned with the sleeve of the rear frame precisely. Moreover, guiding rods on two sides of the front frame are also corresponding to guiding slots on two sides of the rear frame properly. Thus the front frame and the rear frame are joined together and connected to each other. The joining and assembling require higher precision. For users with physical disabilities, or elders with poor physical health, this causes inconvenience in assembling.

Thus the structure of the scooter revealed in the Taiwanese Pat. No. M374858 is not convenient for users with physical disabilities or poor physical health to assembly and use. There is room for improvement and a need to provide a novel vehicle frame join of the scooter.

### SUMMARY OF THE INVENTION

Therefore it is a primary object of the present invention to provide a vehicle frame joint of a folding scooter that is able to be assembled and disassembled easily and quickly by the disabled and users with poor physical health themselves.

In order to achieve the above object, a vehicle frame joint of a folding scooter according to the present invention includes a front frame, a rear frame, connections rods and hooks both disposed between the front frame and the rear frame. The hooks consist of main hooks each of which having an opening facing upward and the side hooks each of which having an openings facing downward. The hooks are secured to the connection rods.

The connection rods include a main connection rod and auxiliary connection rods, arranged transversely at a front side and a rear side. Moreover, the hooks having an opening facing downward and the hooks with an opening facing upward are disposed on a front side and a rear side so as to be secured on the auxiliary connection rods and the main connection rod correspondingly.

Both the main and auxiliary connection rods are disposed on the front frame while the hooks are arranged at the rear frame.

The main connection rod is arranged transversely on the front frame and the auxiliary connection rods are respectively disposed projectingly on an outer edge of each of two sides of the front frame. Two joining rods are respectively extending along each of two sides of the rear frame. The side hook with an opening facing downward is disposed on a front end of the joining rod. A support rod is arranged horizontally between the two joining rods of the rear frame and two main hooks each of which having an opening facing upward are disposed on the support rod.

Moreover, the main and auxiliary connection rods can be disposed on the rear frame while the hooks can be arranged at the front frame.

The main connection rod is disposed transversely on the rear frame and the auxiliary connection rods are respectively disposed projectingly on an outer edge of each of two sides of the rear frame. Two joining rods are respectively extending along each of two sides of the front frame. The side hook with an opening facing downward is disposed on a rear end of the joining rod. A support rod is set horizontally between the two joining rods of the front frame and two main hooks each of which having an opening facing upward are arranged at the support rod.

While in use, the connection rods of one frame are assembled with or separated from the main and side hooks of the other frame so as to connect or disconnect the front frame and the rear frame. According to such simple way of connection, users with physical disabilities or poor physical health can assemble and disassemble the scooter by themselves easily.

Furthermore, the vehicle frame joint of scooters is mainly formed by the main connection rod of the front frame, the auxiliary connection rods of the front frame, the main hooks with openings facing upward of the rear frame, and the side hooks with openings facing downward of the rear frame. The structure is simple. For manufacturers, the manufacturing cost and production time are reduced dramatically and the competitiveness in the market is improved significantly.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment according to the present invention;

FIG. 2 is a partial side view during the assembling of an embodiment according to the present invention;

FIG. 3 is a partial side view of an assembled embodiment according to the present invention;

FIG. 4 is at top view of an embodiment according to the present invention.

### DETAILED DESCRIPTION OF THE PREFERRED EMBODIMENT

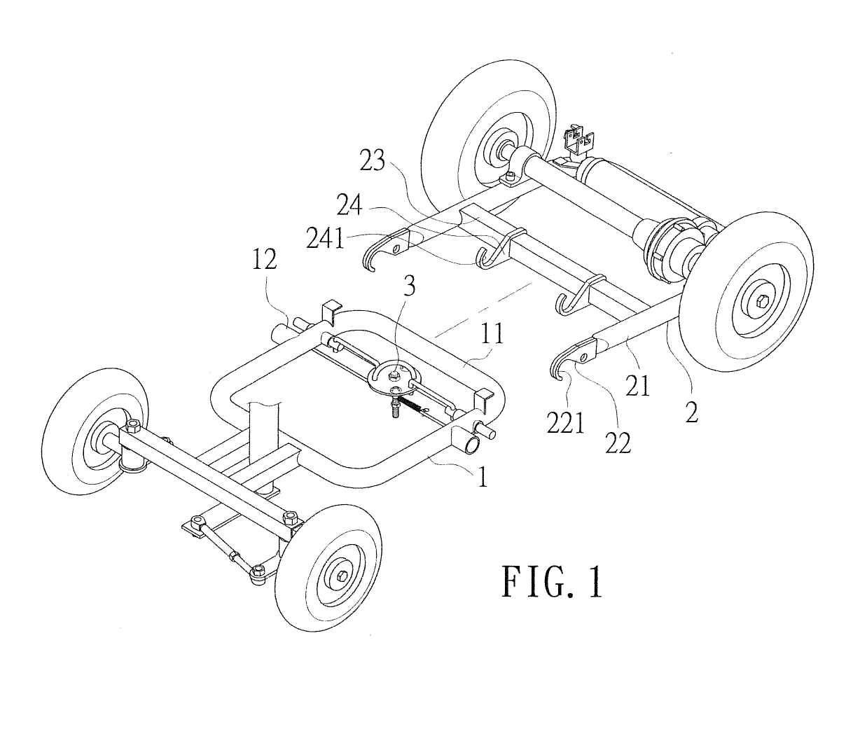

Refer to FIG. 1, a vehicle frame joint of scooters includes a front frame 1 and a rear frame 2.

The front frame 1 includes a main connection rod 11 arranged transversely thereof, two auxiliary connection rods 12 respectively disposed projectingly on an outer edge of each of two sides of the front frame 1. The auxiliary connection rods 12 and the main connection rod 11 are located on a front side and a rear side of the front frame 1.

The rear frame 2 includes two joining rods 21 respectively extending along each of two sides thereof. A side hook 22 with an opening 221 facing downward for being secured to each auxiliary connection rod 12 of the front frame 1 is disposed on a front end of the joining rod 21. A support rod 23 is arranged horizontally between the two joining rods 21 of the rear frame 2 and two main hooks 24 each of which having an opening 241 facing upward are disposed on the support rod 23. The main hooks 24 are used to hook on and connect with the main connection rod 11 of the front frame 1.

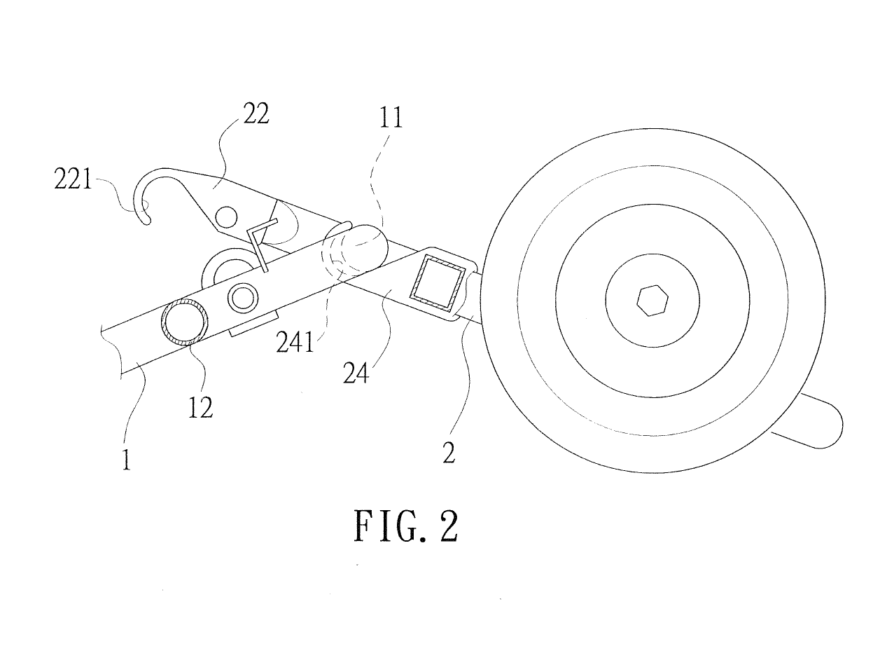

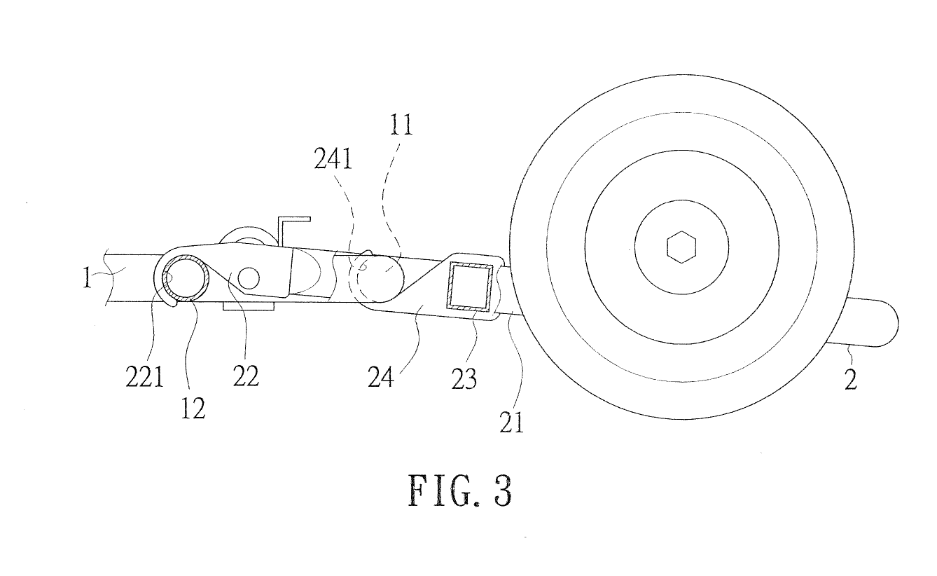

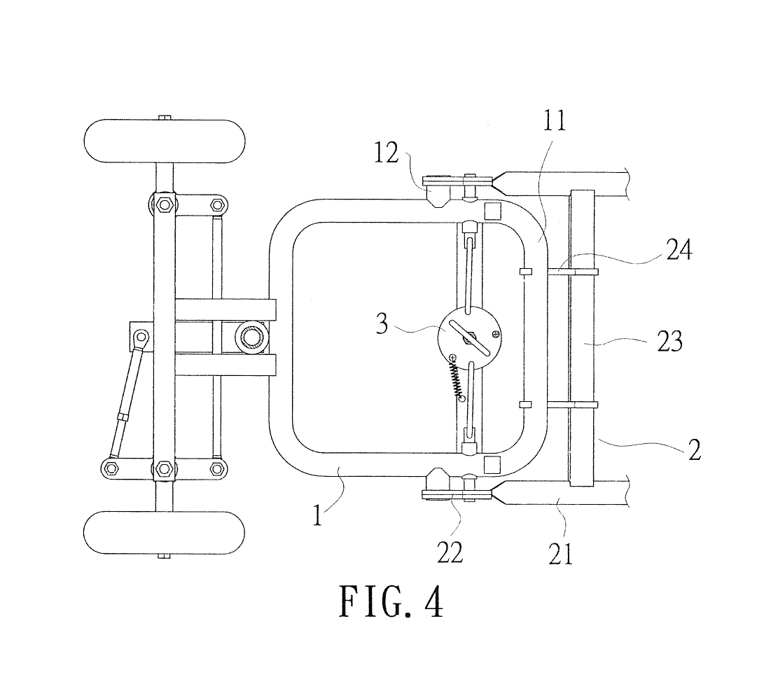

Thereby when a user intends to ride the folding scooter, refer to FIG. 2, the front frame 1 is lifted a little bit. Thus the main connection rod 11 of the front frame 1 is pulled upward to be above the main hooks 24 of the rear frame 2 and then stop pulling the front frame 1, allowing the main connection rod 11 of the front frame 1 being mounted into the openings 241 facing upward and on the main hooks 24 of the rear frame 2. Next, the rear frame 2 is lifted above the front frame 1 so that the openings 221 facing downward and on the side hooks 22 of the rear frame 2 are hooked on the auxiliary connection rods 12 of the front frame 1. Thus the connection between the front frame 1 and the rear frame 2 is completed, as shown in FIG. 3. Later the connected front and rear frames 1, 2 are further fixed by means of a fixing unit 3 arranged therebetween, as shown in FIG. 4. In accordance with the above steps, the front frame 1 and the rear frame 2 are connected with each other easily and quickly to form a complete folding scooter.

When users want to store or transport the scooter, they need to fold the scooter for reducing the volume and offering more convenience in transportation and storage. Refer to FIG. 4 and FIG. 1, the fixing unit 3 for fastening the front frame 1 and the rear frame 2 can be released. Later the main connection rod 11 of the front frame 1 is pulled upward so as to get the main connection rod 11 of the front frame 1 out of the openings 241 on the main hooks 24 of the rear frame 2. Then keep pulling the main connection rod 11 of the front frame 1 forward, allowing the main connection rod 11 to be released from the openings 241 of the main hooks 24 of the rear frame 2 completely. Next stop pulling the main connection rod 11 of the front frame 1. Now the main connection rod 11 of the front frame 1 falls down to the ground. At the same time, without being hooked by the openings 241 of the main hooks 24, the auxiliary connection rods 12 of the front frame 1 are automatically out of the openings 221 of the side hooks 22 of the rear frame 2 due to the gravity. Thus the front and the rear frames 1, 2 are disconnected. Then the front frame 1 and the rear frame 2 are overlapped with each other. Thus the volume of the vehicle frame of the scooter is reduced significantly so as to achieve convenient transportation and easy storage.

Through the above procedures, it is learned that the design of the vehicle frame joint of the scooter according to the present invention not only simplifies manufacturing, but also effectively reduces manufacturing cost and production time. Moreover, the assembly and disassembly of the vehicle frame are simple and convenient. Thus main scooter users such as disables, frail elders, etc can assemble and disassemble the vehicle frame easily by themselves.

In other embodiments, the main connection rod 11 and the auxiliary connection rods 12 can be disposed on the rear frame 2 while the side hooks 22 and the main hooks 24 are arranged at the front frame 1.

In summary, the present invention has following advantages:
1. While in use, the user only need to connect or separate the main connection rod and the auxiliary connection rods of the front frame with the main hooks and the side hooks of the rear frame for assembly and disassembly of the front frame and the rear frame. Thus even the disabled or people with poor physical health can also complete the assembly and disassembly of the vehicle frame of the scooter by themselves.
2. The vehicle frame joint of scooters is mainly formed by the main connection rod of the front frame, the auxiliary connection rods of the front frame, the main hooks with openings facing upward of the rear frame, and the side hooks with openings facing downward of the rear frame. The structure is simple. For manufacturers, such design reduces the manufacturing cost and production time dramatically. The competitiveness in the market is improved significantly.
3. The front frame and the rear frame can be disassembled. By such design, the volume of the scooter can be reduced for convenient transportation and easy storage.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A vehicle frame joint of scooters comprising: a front frame and a rear frame;
wherein the front frame and the rear frame are disposed with connection rods and hooks respectively; the hooks include main hooks each of which having an opening facing upward and side hooks each of which having an opening facing downward so as to assemble with the connection rods.

2. The device as claimed in claim 1, wherein the connection rods includes at least one main connection rod and auxiliary connection rods; the main hooks each of which having an opening facing upward and the side hooks each of which having an opening facing downward are secured to the main connection rod and the auxiliary connection rods respectively.

3. The device as claimed in claim 2, wherein the connection rods are disposed on the front frame and the hooks are arranged at the rear frame.

4. The device as claimed in claim 3, wherein the main connection rod is arranged transversely at the front frame and the auxiliary connection rods are respectively disposed projectingly on an outer edge of each of two sides of the front frame; two joining rods are respectively extending along each of two sides of the rear frame; the side hook with an opening facing downward is disposed on a front end of the joining rod; a support rod is arranged horizontally between the two joining rods of the rear frame and the main hooks each of which having an opening facing upward are disposed on the support rod.

5. The device as claimed in claim 2, wherein the connection rods are disposed on the rear frame and the hooks are arranged at the front frame.

6. The device as claimed in claim 5, wherein the main connection rod is arranged transversely at the rear frame and the auxiliary connection rods are respectively disposed projectingly on an outer edge of each of two sides of the rear frame; two joining rods are respectively extending along each of two sides of the front frame; the side hook with an opening facing downward is disposed on a rear end of the joining rod; a support rod is arranged horizontally between the two joining rods of the front frame and the main hooks each of which having an opening facing upward are disposed on the support rod.

7. The device as claimed in claim 1, wherein the connection rods are disposed on the front frame and the hooks are arranged at the rear frame.

8. The device as claimed in claim 1, wherein the connection rods are disposed on the rear frame and the hooks are arranged at the front frame.
